(19) United States
(12) Patent Application Publication
(10) Pub. No.: US 2024/0217604 A1
(43) Pub. Date: Jul. 4, 2024

(54) BICYCLE STAND

(71) Applicant: INEN INC., Taichung City (TW)

(72) Inventors: SHIH-TI LIN, Taichung City (TW); HUNG-JU LEE, Taichung City (TW)

(21) Appl. No.: 18/399,025

(22) Filed: Dec. 28, 2023

(30) Foreign Application Priority Data
Dec. 29, 2022 (TW) 111150709

(51) Int. Cl. B62H 1/02

(52) U.S. Cl. CPC B62H 1/02

(57) ABSTRACT

A bicycle stand is provided, including: a first connecting portion, a main body and at least two supporting members. The first connecting portion is configured to be assembled to a frame of a bicycle. The main body includes a rod member and a base connected with the rod member, and the rod member defines an axial direction and includes a second connecting portion detachably connected with the first connecting portion. The at least two supporting members are connected with the base and respectively include at least one supporting surface configured to be abutted against a placement surface, and the at least two supporting members are movable relative to the main body between an expanding position and a folded position.

### BACKGROUND OF THE INVENTION

### Field of the Invention

The present invention relates to a bicycle stand.

### Description of the Prior Art

A conventional bicycle stand includes two rod members extending in U-shaped and two pivot mechanisms, and two ends of each of the two rod members are respectively connected with the two pivot mechanisms so as to be moved relative to each other. A wheel shaft of the bicycle can be positioned between the two pivot mechanisms so as to achieve support effect.

However, the two rod members of the conventional bicycle stand respectively have small contact surface, which has poor stability and insufficient load-bearing capacity. Moreover, a rider cannot ride the bicycle when parking, and the bicycle stand has a single function and is inconvenient to use.

The present invention is, therefore, arisen to obviate or at least mitigate the above-mentioned disadvantages.

### SUMMARY OF THE INVENTION

The main object of the present invention is to provide a bicycle stand, which is easy to be assembled and disassembled and provides stable support.

To achieve the above and other objects, the present invention provides a bicycle stand, including: a first connecting portion, a main body and at least two supporting members. The first connecting portion is configured to be assembled to a frame of a bicycle. The main body includes a rod member and a base connected with the rod member, and the rod member defines an axial direction and includes a second connecting portion detachably connected with the first connecting portion. The at least two supporting members are connected with the base and respectively include at least one supporting surface configured to be abutted against a placement surface, and the at least two supporting members are movable relative to the main body between an expanding position and a folded position.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a first preferable embodiment of the present invention in use;

FIG. 2 is a partial breakdown drawing of the first preferable embodiment of the present invention;

FIG. 3 is partial stereogram of the first preferable embodiment of the present invention when two supporting members are in an expanding position;

FIG. 4 is a side view of FIG. 3;

FIG. 5 is another stereogram of the first preferable embodiment of the present invention in use;

FIG. 6 is a schematic diagram showing operation of the first preferable embodiment of the present invention;

FIG. 7 is a cross sectional view of the first preferable embodiment of the present invention when the two supporting members are in a folded position; and

FIG. 8 is a partial breakdown drawing of a second preferable embodiment of the present invention; and

FIG. 9 is a schematic diagram showing operation of the second preferable embodiment of the present invention.

### DETAILED DESCRIPTION OF THE PREFERRED EMBODIMENTS

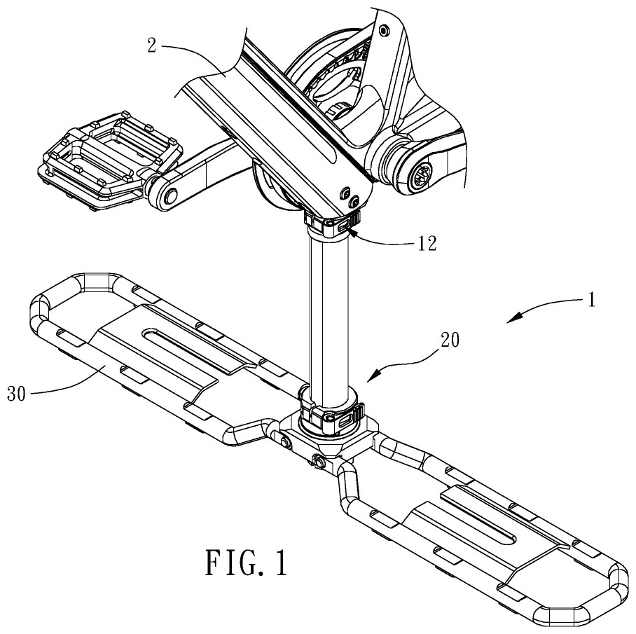

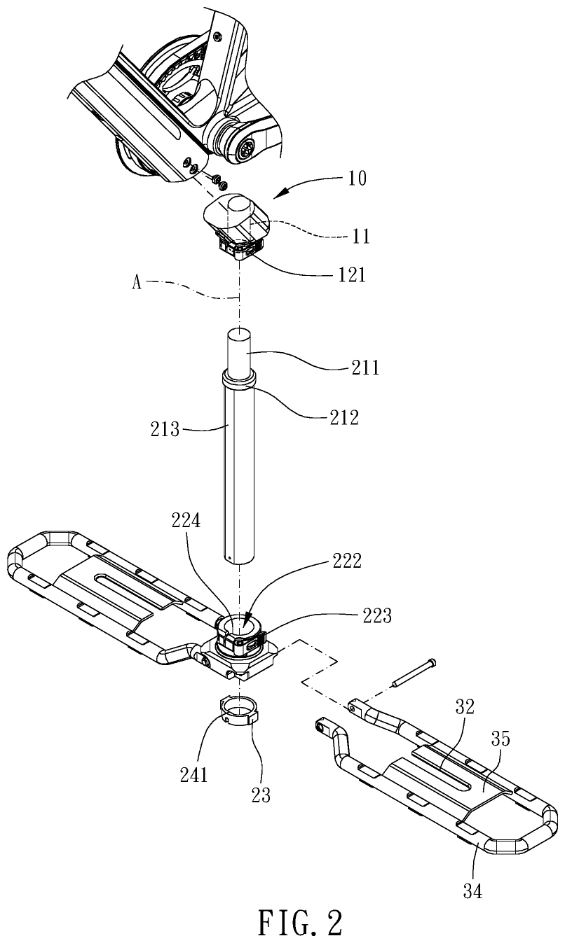

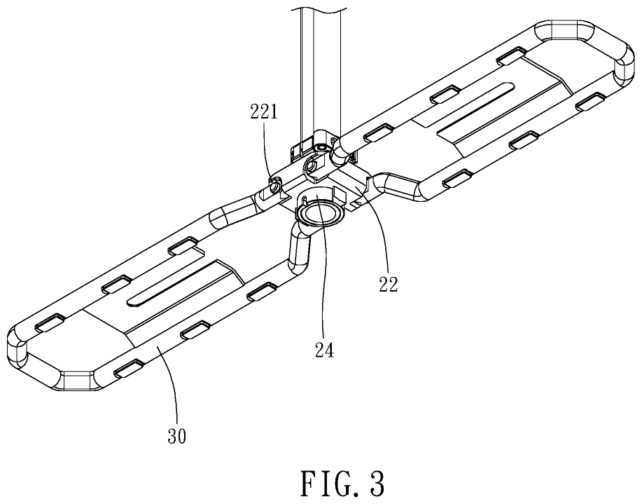

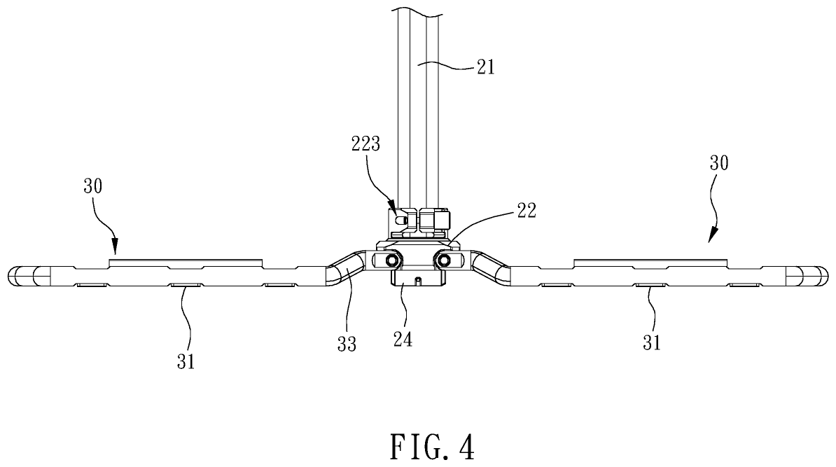

Please refer to FIGS. 1 to 7 for a first preferable embodiment of the present invention. A bicycle stand 1 of the present invention includes a first connecting portion 10, a main body 20 and at least two supporting members 30.

The first connecting portion 10 is configured to be assembled to a frame of a bicycle. The main body 20 includes a rod member 21 and a base 22 connected with the rod member 21, and the rod member 21 defines an axial direction A and includes a second connecting portion 211 detachably connected with the first connecting portion 10. The at least two supporting members 30 are connected with the base 22 and respectively include at least one supporting surface 31 configured to be abutted against a placement surface, and the at least two supporting members 30 are movable relative to the main body 20 between an expanding position and a folded position. Therefore, the bicycle stand 1 cab be rapidly assembled and disassembled and provides stable support and easy storage.

In this embodiment, each of the at least two supporting members 30 is swingably connected with the base 22, and the at least two supporting members 30 are swingable in a direction remote from the second connecting portion 211 and toward each other so as to be moved to the folded position. The base 22 includes a plurality of restricting surfaces 221, and each of the plurality of restricting surfaces 221 is interfereable with one of the at least two supporting members 30 in a swinging path of one of the at least two supporting members 30 so as to avoid over-swinging of the at least two supporting members 30 and provide good supporting stability. Preferably, the bicycle stand 1 includes two said supporting members 30 which are radially arranged at two opposite sides of the base 22, which has a simple structure and provides stable support. In other embodiments, a number of the at least two supporting members may be changed to meet different requirements, for example, the bicycle stand may include three said supporting members, which also can provide stable support effect. The at least two supporting members may be swung in a direction toward the second connecting portion and toward each other so as to be moved to the folded position. Each of the at least two supporting members may have a stretching mechanism being stretchable relative to the base, which also can provide the effects of reducing the size and facilitating storage.

The first connecting portion 10 is configured to be assembled to a down tube 2 of the frame so that the bicycle stand 1 supports a middle portion of the bicycle for good stability. The first connecting portion 10 includes a first insertion groove 11 and a first bundling portion 12 disposed around the first insertion groove 11, the second connecting portion 211 is a convex pillar, and the rod member 21 further includes a radial flange 212 adjacent to the convex pillar. When the convex pillar is inserted within the first insertion groove 11, the first bundling portion 12 is axially abuttable against the radial flange 212 and adjustably pressed against an outer circumferential surface of the convex pillar for positioning. The first bundling portion 12 may include a quick-release assembly 121 so as to quickly assemble and disassemble the bicycle stand 1, and a height of the main body 20 is easy to be adjusted.

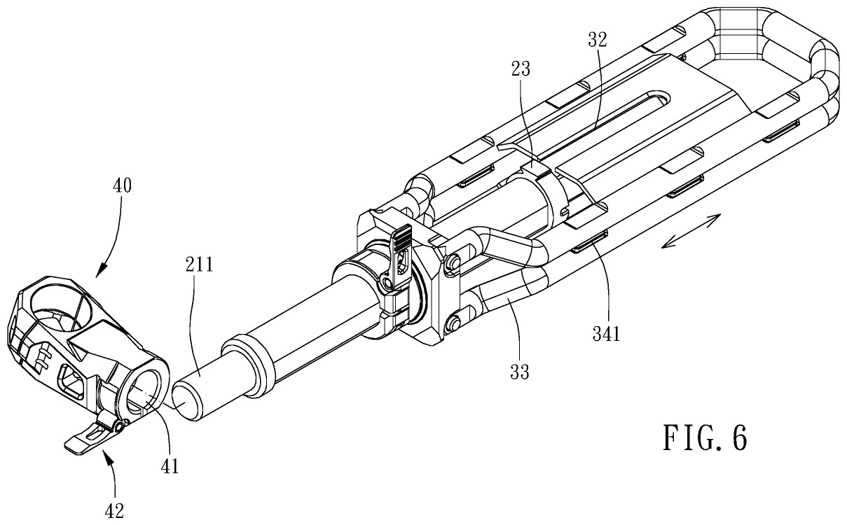

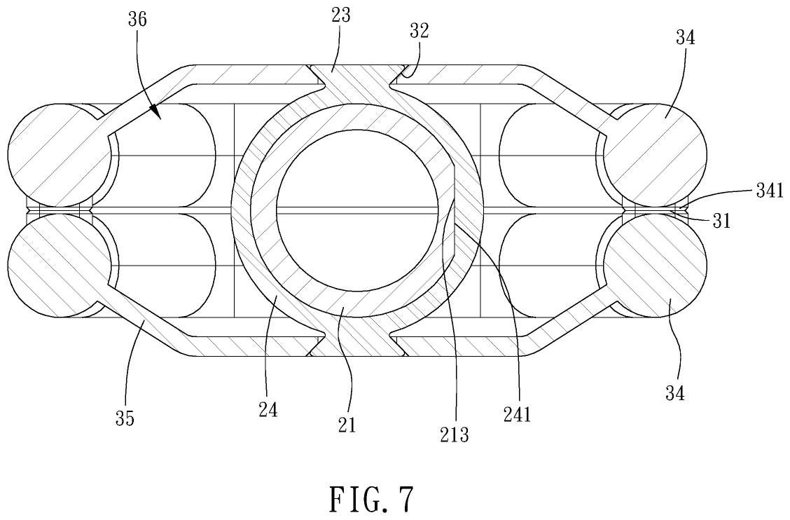

Preferably, the main body 20 includes at least two first engaging portions 23, and each of the two said supporting members 30 includes a second engaging portion 32. When the two said supporting members 30 are in the folded position, each said second engaging portion 32 is detachably engaged with one of the at least two first engaging portions 23, which prevents the at least two supporting members 30 from being expanded unexpectedly and is easy to store and carry. Specifically, the main body 20 further includes a ring member 24 sleeved to the rod member 21. The at least two first engaging portions 23 are at least two engaging projections radially protruding from the ring member 24, and each said second engaging portion 32 is an engaging groove extending in a longitudinal direction of one of the two said supporting members 30. When the two said supporting members 30 are moved to the folded position, the base 2 is moved relative to the rod member 21 in the axial direction A and drives each of the at least two engaging projections to be engaged within one said engaging groove, as shown in FIGS. 6 and 7, which is easy to operate and provides stable engagement. In other embodiments, each of the at least two first engaging portions and each said second engaging portion may be deformably engaged with or abutted against with each other.

In this embodiment, the base 22 includes an opening 222 and a second bundling portion 223 disposed around the opening 222. The rod member 21 is disposed through the opening 222, and the second bundling portion 223 is adjustably pressed against an outer circumferential surface of the rod member 21. When the two said supporting members 30 are in the expanding position, the second bundling portion 223 is urged to the rod member 21 so as to position the base 22 and the at least two supporting members 30 in the axial direction A. When the two said supporting members 30 are in the folded position, the second bundling portion 223 is released so that the base 22 is axially movable along the rod member 21, and each of the at least two engaging projections is engaged within one said engaging groove for positioning. Preferably, the ring member 24 is located at a side of the base 22 remote from the second connecting portion 211; when the two said supporting members 30 are in the expanding position, the base 22 is abutted against the ring member 24 in the axial direction A so as to prevent the base 22 from being detached from the rod member 21. In addition, the ring member 24 and the two said supporting members 30 provides multiple surfaces for stable support. The rod member 21 further includes a first cutting surface 213 extending in the axial direction A, the base 22 includes a second cutting surface 224 corresponding to the first cutting surface 213, and the ring member 24 includes a third cutting surface 241 corresponding to the first cutting surface 213, which prevents the base 22 and the ring member 24 from being rotated relative to the rod member 21 and is convenient to be assembled. In other embodiments, the ring member may be arranged at a side of the base adjacent to the second connecting portion; the ring member may integrally protrude from the rod member; and each of the at least two engaging projections may directly protrude from the outer circumferential surface of the rod member.

Specifically, the bicycle stand cooperates with a front wheel of the bicycle so that the bicycle stably stands on the placement surface and a rear wheel of the bicycle is suspended. As a result, the bicycle stand provides a support force on a central plane of the bicycle, which allows a rider to ride the bicycle for training when the bicycle is parked.

Each of the two said supporting members 30 includes at least one connecting section 33 rotatably connected with the base 22, and each of the at least one connecting section 33 extends obliquely toward a side remote from the at least one supporting surface 31. When the two said supporting members 30 are in the expanding position, said supporting surfaces 31 of the two said supporting members 30 are configured to be abutted against the placement surface, and said connecting sections 33 of the two said supporting members 30 are spaced apart from the placement surface so as to provide multi-faceted support and stable support. The said connecting sections 33 has good structural strength so that the two said supporting members 30 are not easy to deform due to unexpected force. The two said supporting members 30 contact the said supporting surfaces 31 when being in the folded position, and said connecting sections 33 facing to one another are arranged at intervals, which is easy to store and not easy to be deformed. Moreover, each of the two said supporting members 30 includes a frame portion 34 and at least one extending portion 35, and each said extending portion 35 is connected across two opposite sides of one said frame portion 34 and bendly extends toward a side remote from the at least one supporting surface 31. When the two said supporting members 30 are in the folded position, said frame portions 34 and said extending portions 35 define a receiving space 36 therebetween, and the main body 20 is partially received within the receiving space 36, as shown in FIG. 7, which contributes to miniaturization and easy storage. In this embodiment, a side of each said frame portion 34 remote from the second connecting portion 211 has a plurality of abutting projections 341 spaced apart from one another, and each of the plurality of abutting projections 341 has one said supporting surface 31 disposed thereon so as to provide multi-faceted support and good stability. Each said engaging groove is disposed through one said the extending portion 35. Therefore, when the two said supporting members 30 are moved to the folded position, each of the at least two engaging projections are moved in the axial direction A and engaged within one said engaging groove, which is easy to operate and provides stable engagement. In other embodiments, the frame portion may have a plurality of said extending portions disposed thereon; each said engaging groove may be disposed on the frame portion; each of the two said supporting members may have a supporting surface continuously extending on the frame portion be a board extending continuously.

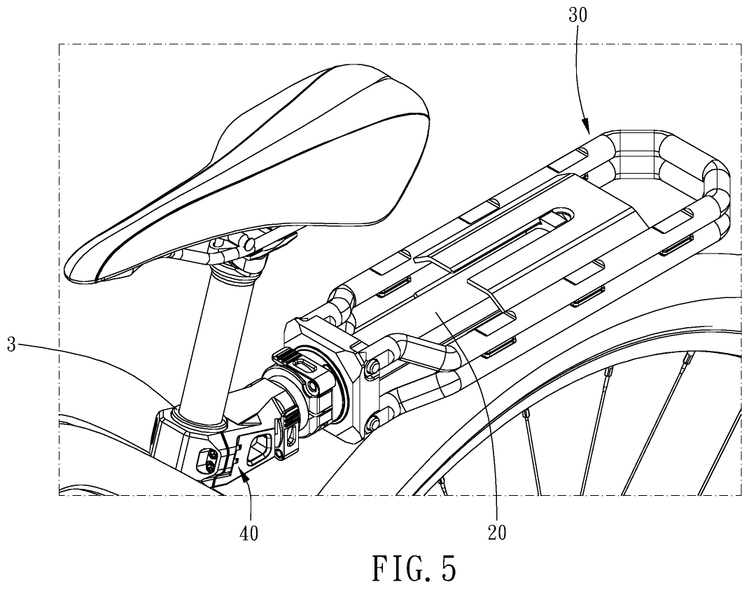

Please refer to FIGS. 5 and 6, the bicycle stand 1 further includes a third connecting portion 40, and the third connecting portion 40 is configured to be assembled to a seat tube 3 of the frame. When the two said supporting members 30 are in the folded position, the second connecting portion 211 is detachably connected with the third connecting portion 40. Therefore, the bicycle stand 1 can be used as a shelf and configured for an object to be placed thereon, such as saddle bags, shelf bags, etc. The third connecting portion 40 includes a second insertion groove 41 and a third bundling portion 42 disposed around the second insertion groove 41. When the convex pillar is inserted within the second insertion groove 41, the third bundling portion 42 is axially abuttable against the radial flange 212 and adjustably pressed against an outer circumferential surface of the convex pillar, which provide easy operation and good assembling stability.

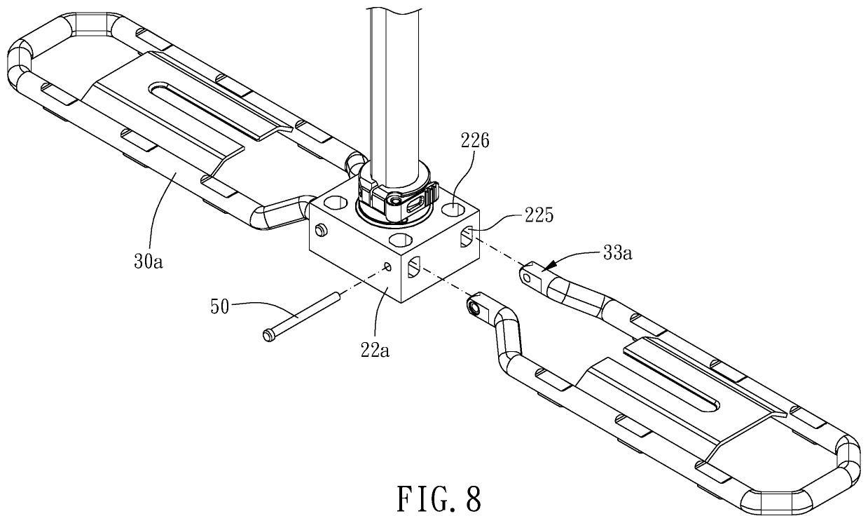

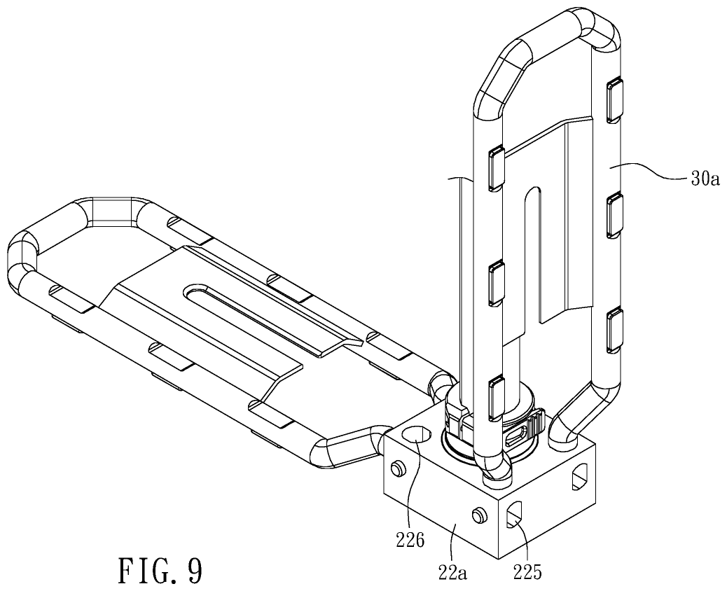

Please refer to FIGS. 8 and 9 showing a second preferable embodiment of the present invention. The base 22a further includes a plurality of first receiving holes 225 extending lateral to the axial direction A and a plurality of second receiving holes 226 extending parallel to the axial direction A. The at least one connecting section 33a of each of the two said supporting members 30a is detachably inserted within one of said first receiving holes 225 or one of said second receiving holes 226 so as to be moved to the folded position or the expanding position. In this embodiment, each said connecting section 33a is positioned to the base 22a by a pin 50. In other embodiments, each of the two said supporting members may have a single said connecting section; each said connecting section may be positioned to the base by buckling, screwing, tight-fitting connections, etc.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A bicycle stand, including:
a first connecting portion, configured to be assembled to a frame of a bicycle;
a main body, including a rod member and a base connected with the rod member, the rod member defining an axial direction and including a second connecting portion detachably connected with the first connecting portion; and
at least two supporting members, connected with the base and respectively including at least one supporting surface configured to be abutted against a placement surface, the at least two supporting members being movable relative to the main body between an expanding position and a folded position.

2. The bicycle stand of claim 1, wherein each of the at least two supporting members is swingably connected with the base, the base includes a plurality of restricting surfaces, each of the plurality of restricting surfaces is interfereable with one of the at least two supporting members in a swinging path of one of the at least two supporting members.

3. The bicycle stand of claim 1, wherein each of the at least two supporting members includes at least one connecting section rotatably connected with the base, each of the at least one connecting section extends obliquely toward a side remote from the at least one supporting surface; when the at least two supporting members are in the expanding position, said supporting surfaces of the at least two supporting members are configured to be abutted against the placement surface, and said connecting sections of the at least two supporting members are spaced apart from the placement surface.

4. The bicycle stand of claim 1, wherein the main body includes at least two first engaging portions, each of the at least two supporting members includes a second engaging portion; when the at least two supporting members are in the folded position, each said second engaging portion is detachably engaged with one of the at least two first engaging portions.

5. The bicycle stand of claim 4, wherein the main body further includes a ring member sleeved to the rod member, the at least two first engaging portions are at least two engaging projections radially protruding from the ring member, each said second engaging portion is an engaging groove extending in a longitudinal direction of one of the at least two supporting members; when the at least two supporting members are moved to the folded position, the base is moved relative to the rod member in the axial direction and drives each of the at least two engaging projections to be engaged within one said engaging groove.

6. The bicycle stand of claim 1, wherein each of the at least two supporting members includes a frame portion and at least one extending portion, each said extending portion is connected across two opposite sides of one said frame portion and bendly extends toward a side remote from the at least one supporting surface; when the at least two supporting members are in the folded position, said frame portions and said extending portions define a receiving space therebetween, the main body is partially received within the receiving space.

7. The bicycle stand of claim 1, wherein the first connecting portion includes a first insertion groove and a first bundling portion disposed around the first insertion groove, the second connecting portion is a convex pillar, the rod member further includes a radial flange adjacent to the convex pillar; when the convex pillar is inserted within the first insertion groove, the first bundling portion is axially abuttable against the radial flange and adjustably pressed against an outer circumferential surface of the convex pillar.

8. The bicycle stand of claim 1, wherein the base includes an opening and a second bundling portion disposed around the opening, the rod member is disposed through the opening, and the second bundling portion is adjustably pressed against an outer circumferential surface of the rod member.

9. The bicycle stand of claim 1, further including a third connecting portion, wherein the third connecting portion is configured to be assembled to a seat tube of the frame; when the at least two supporting members are in the folded position, the second connecting portion is detachably connected with the third connecting portion.

10. The bicycle stand of claim 5, wherein the bicycle stand includes two said supporting members which are radially arranged at two opposite sides of the base; each of the two said supporting members is swingably connected with the base, the base includes a plurality of restricting surfaces, each of the plurality of restricting surfaces is interfereable with one of the two said supporting members in a swinging path of one of the two said supporting members; each of the two said supporting members includes at least one connecting section rotatably connected with the base, each of the at least one connecting section extends obliquely toward a side remote from the at least one supporting surface; when the two said supporting members are in the expanding position, said supporting surfaces of the two said supporting members are configured to be abutted against the placement surface, and said connecting sections of the two said supporting members are spaced apart from the placement surface; each of the two said supporting members includes a frame portion and at least one extending portion, each said extending portion is connected across two opposite sides of one said frame portion and bendly extends toward a side remote from the at least one supporting surface; when the two said supporting members are in the folded position, said frame portions and said extending portions define a receiving space therebetween, the main body is partially received within the receiving space; a side of each said frame portion remote from the second connecting portion has a plurality of abutting projections spaced apart from one another, each of the plurality of abutting projections has one said supporting surface disposed thereon; each said engaging groove is disposed through one said extending portion; the first connecting portion includes a first insertion groove and a first bundling portion disposed around the first insertion groove, the second connecting portion is a convex pillar, the rod member further includes a radial flange adjacent to the convex pillar; when the convex pillar is inserted within the first insertion groove, the first bundling portion is axially abuttable against the radial flange and adjustably pressed against an outer circumferential surface of the convex pillar; the base includes an opening and a second bundling portion disposed around the opening, the rod member is disposed through the opening, and the second bundling portion is adjustably pressed against an outer circumferential surface of the rod member; the first connecting portion is configured to be assembled to a down tube of the frame; the bicycle stand further includes a third connecting portion, the third connecting portion is configured to be assembled to a seat tube of the frame; when the two said supporting members are in the folded position, the second connecting portion is detachably connected with the third connecting portion; the third connecting portion includes a second insertion groove and a third bundling portion disposed around the second insertion groove; when the convex pillar is inserted within the second insertion groove, the third bundling portion is axially abuttable against the radial flange and adjustably pressed against an outer circumferential surface of the convex pillar; the ring member is located at a side of the base remote from the second connecting portion, when the two said supporting members are in the expanding position, the base is axially abutted against the ring member; and the rod member further includes a first cutting surface extending in the axial direction, the base includes a second cutting surface corresponding to the first cutting surface, the ring member includes a third cutting surface corresponding to the first cutting surface.
